(19) United States
(12) Patent Application Publication
(10) Pub. No.: US 2025/0264894 A1
(43) Pub. Date: Aug. 21, 2025

(54) APPARATUS AND METHOD FOR PREVENTING MOLD GROWTH

(71) Applicant: Mirza Faizan, Irving, TX (US)

(72) Inventors: Mirza Faizan, Irving, TX (US); Abdullah Kabeer, Plano, TX (US); Meher Saanvi Singh, Southlake, TX (US); Karim Medhat Askar, Southlake, TX (US); Malak Askar, Southlake, TX (US); Hadiya Sameen, Mount Sinai, NY (US); Iliyan Ali Mithani, Allen, TX (US); Saanchi Gabri, Frisco, TX (US); Zara Majid, Keller, TX (US); Tarik Syed, Dallas, TX (US); Shayaan Shaik, Edison, NJ (US); Mirza Rizwan, Patna (IN); Nadia Anisa Sethuraman, Dallas, TX (US); Zaid Marwat, Allen, TX (US); Aarish Salman Bhojani, Euless, TX (US); Jiya Saanvi Singh, Southlake, TX (US); Amreen Syed, Edison, NJ (US)

(21) Appl. No.: 18/582,752

(22) Filed: Feb. 21, 2024

(51) Int. Cl. G05D 22/02; H05B 3/26

(52) U.S. Cl. CPC G05D 22/02; H05B 3/26

(57) ABSTRACT

An apparatus, a method, and an insulated module to control mold growth is provided. The apparatus includes an enclosing structure defining a chamber therewithin to receive an insulation layer, a projection array comprising projections extending within the insulation layer, a heating element mechanically coupled with the enclosing structure to generate heat to cause the enclosing structure to conduct heat to the insulation layer, and a controller communicatively coupled with humidity sensor and the heating element. The enclosing structure is made of a heat conductive element. At least some of the projections are configured to host the humidity sensor to measure humidity data of the insulation layer. The controller is configured to generate a control signal to trigger the heating element based on a comparison between the humidity data and a humidity threshold.

### TECHNICAL FIELD

The present invention relates generally to preventing mold growth, and more particularly the present invention relates to an apparatus and a method to prevent mold growth within an insulation material.

### BACKGROUND

Walls are fundamental components of the building structures, providing essential support and defining a boundary between indoor and outdoor spaces. Traditionally, walls have been constructed using various materials, such as stone, wood and concrete. In recent years, insulation materials or gaps are added between an exterior and an interior face of walls to enhance insulation to regulate indoor temperature and energy efficiency.

Mold growth in walls and interior spaces of buildings is a persistent issue that affects the health of occupants and the integrity of the structure itself. Traditional methods of mold control often rely on reactive measures, such as chemical treatments or remediation after the mold has already established itself. These approaches can be costly, time-consuming, and may only offer temporary relief.

Therefore, there is a need to overcome drawbacks associated with the conventional methods of handling mold growth in walls.

### SUMMARY

The present disclosure provides an apparatus and a method for preventing mold growth within the walls.

In one aspect, an apparatus for preventing mold growth is disclosed. The apparatus comprises an enclosing structure. The enclosing structure defines a chamber therewithin to receive an insulation layer. The enclosing structure is made of a heat conductive element. Further, the apparatus comprises a projection array arranged in association with the insulation layer. The projection array comprises a plurality of projections extending within the insulation layer. Moreover, at least some of the plurality of projections are configured to host a humidity sensor to measure humidity data of the insulation layer. The apparatus further comprises a heating element mechanically coupled with the enclosing structure. The heating element is configured to generate heat to cause the enclosing structure to conduct heat to the insulation layer. The apparatus further comprises a controller communicatively coupled with the humidity sensor and the heating element. The controller is configured to generate a control signal to trigger the heating element based on a comparison between the humidity data and a humidity threshold.

According to some embodiments, a plurality of projection arrays is arranged within the insulation layer.

According to some embodiments, the plurality of projections of the projection array extends perpendicularly from a surface of at least one of: a first side, or a second side opposite to the first side, of the projection array within the insulation layer.

According to some embodiments, the heating process comprises at least one of: activating the heating element, adjusting one or more vents, adjusting a humidity condition for the insulation layer, and deactivating the heating element when a cut-off is reached.

According to some embodiments, one or more projections of the plurality of projections are in connection with the heating element, and wherein the heating element conducts heat to the insulation layer through the one or more projections during the heating process.

According to some embodiments, each of the plurality of projections includes an outlet for hosting at least one of: the humidity sensor, a temperature sensor, a heating element, or a vent for heat distribution.

According to some embodiments, the insulation layer includes a plurality of regions, and wherein each of the plurality of regions includes at least one projection hosting the humidity sensor, at least one projection in connection with the heating element, and at least one projection hosting a temperature sensor.

According to some embodiments, the controller is further configured to detect a humidity condition for each of the plurality of regions of the insulation layer based on the corresponding humidity data and the humidity threshold. Further the controller is configured to transmit a control signal to the at least one projection in connection with heating element associated with at least one region to initiate the heating process based on detecting the humidity condition for the at least one region from the plurality of regions to be prone to mold growth.

According to some embodiments, the controller is remotely connected to a user device. The controller is configured to receive a control input from the user device, generate a temperature control signal for the heating element based on the control input, and transmit the temperature control signal to the heating element to initiate a temperature control. The control input is associated with the temperature control of the insulation layer.

According to some embodiments, the controller is configured to continuously retrieve real-time humidity data after initiating the heating process, determine whether current real-time humidity data from the continuously retrieved real-time humidity data is less than or substantially equal to a cut-off humidity threshold, and generate a control signal for deactivating the heating element based on the determination.

According to some embodiments, one or more projections of the plurality of projections are provided with a temperature sensor to measure temperature data associated with the insulation layer.

According to some embodiments, the enclosing structure is made of iron mesh.

According to some embodiments, the enclosing structure is used to enclose the insulation layer inside a wall of a building.

In another aspect, an insulated wall structure is disclosed. The insulated wall structure comprises an enclosing structure defining a chamber therewithin to receive an insulation layer. The enclosing structure is made of a heat conductive element. The insulated wall structure comprises a projection array arranged in association with the insulation layer. The projection array comprises a plurality of projections extending within the insulation layer. At least some of the plurality of projections are configured to host a humidity sensor to measure humidity data of the insulation layer. The insulated wall structure comprises a heating element mechanically coupled with the enclosing structure, and a controller communicatively coupled with the humidity sensor and the heating element. The heating element is configured to generate heat to cause the enclosing structure to conduct heat to the insulation layer. The controller is configured to generate a control signal to trigger the heating element based on a comparison between the humidity data and a humidity threshold.

In yet another aspect, a method for preventing mold growth is disclosed. The method is implemented using an apparatus comprising an enclosing structure defining a chamber therewithin to receive an insulation layer, wherein the enclosing structure is made of a heat conductive element. The apparatus comprises a projection array arranged in association with the insulation layer. The projection array comprises a plurality of projections extending within the insulation layer. Moreover, at least some of the plurality of projections are configured to host a humidity sensor to measure humidity data of the insulation layer. The apparatus comprises a heating element mechanically coupled with the enclosing structure, and a controller communicatively coupled with the humidity sensor and the heating element. The heating element is configured to generate heat to cause the enclosing structure to conduct heat to the insulation layer. The method comprises iteratively retrieving the humidity data; detecting humidity condition for the insulation layer based on the humidity data and a humidity threshold; and generating and transmitting a control signal to the heating element to initiate a heating process based on detecting the humidity condition to be prone to mold growth.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a block diagram of an exemplary network environment in which an apparatus for preventing mold growth is implemented, according to some embodiments;

FIG. 2 illustrates a block diagram of a controller of the apparatus, according to some embodiments;

FIG. 3 illustrates a flowchart of an exemplary method for preventing the mold growth, according to some embodiments;

FIG. 4A illustrates an exemplary diagram of a wall structure for receiving an insulated module, according to some embodiments;

FIG. 4B illustrates an exemplary diagram of the insulated module according to the present disclosure fitted within the wall structure, according to some embodiments;

FIG. 5A illustrates an exemplary schematic diagram of an enclosing structure, according to some embodiments;

FIG. 5B illustrates an exemplary schematic diagram of a projection array, according to some embodiments;

FIG. 5C illustrates an exemplary schematic diagram of the enclosing structure housing the projection array, according to some embodiments; and

FIG. 6 illustrates a flowchart of a method for preventing mold growth, according to some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

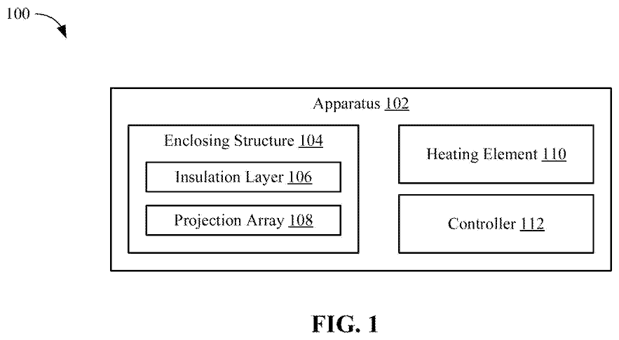

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of a system for providing a user with an interactive map.

Wall serves as integral component of building structures, defining spaces, providing support, and contributing to overall stability. Over time, construction methods have evolved, introducing various materials and technologies to enhance wall functionalities. To provide the insulation from the outdoor environment integration of insulation materials within a wall structure has become a prominent strategy. The insulation material may be provided within a gap between an interior surface and an exterior surface of the wall structure. The insulation material may include, for example, insulation foam, which plays an important role in regulating temperature and reducing energy consumption. The insulation material, commonly made of expanded polystyrene or polyurethane foam, acts as a thermal barrier, preventing heat transfer and contributing to improved insulation performance and energy efficiency of heating and/or cooling systems of buildings.

Despite the benefits of insulation materials, they are susceptible to mold growth due to moisture infiltration. For example, damp environment within the insulation material that may arise during rainy seasons, flooding, bad plumbing in the house, etc., may become suitable for mold growth within the insulation material. The mold growth can have detrimental effects on both structural integrity of the building and human health.

Conventionally, methods for addressing mold growth include individuals resorting to post-detection solutions, such as using chemical agents like fungicides or applying antimicrobial treatments on surfaces where mold is visibly present. Physical removal, such as scrubbing or sanding, is another common approach. However, these conventional methods tend to be labor-intensive, time-consuming, and may only provide a temporary solution, as they do not address the root cause of mold formation.

Embodiments of present disclosure provide techniques for inhibiting mold growth within an insulation material of walls. Recognizing the prevalent challenge of mold proliferation in humid environments, the techniques described in the present disclosure provide a multifaceted approach for mold growth prevention. According to the present disclosure, an apparatus for preventing mold growth is provided. The apparatus is capable of dynamically monitoring, detecting, and proactively addressing environmental conditions that may lead to mold growth within an insulation material. In this manner, by continuously monitoring environmental conditions, the apparatus may detect and address mold-friendly conditions before visible growth occurs, preventing the need for extensive remediation. The apparatus may be integrated seamlessly into existing construction and building maintenance frameworks, providing an efficient and sustainable approach to mold prevention.

The proactive approach reduces the need for costly remediation efforts, saving building owners and occupants both time and money. In addition, by creating a healthier indoor environment by preventing mold growth, the apparatus contributes to improved occupant health and wellbeing. Further, the targeted interventions and proactive approach of the apparatus aligns with sustainability goals by minimizing the use of harmful chemicals and reducing the environmental impact associated with mold remediation.

FIG. 1 is a block diagram of an exemplary network environment 100 in which an apparatus 102 for preventing mold growth is implemented, according to some embodiments. The apparatus 102 includes an enclosing structure 104, a projection array 108, a heating element 110 and a controller 112.

The enclosing structure 104 refers to a physical framework or a structure, providing the necessary containment for an insulation layer 106. In an example, the enclosing structure 104 may accommodate and secure the insulation layer 106 within the walls of a building. The enclosing structure 104 along with the insulation layer 106 may provide thermal insulation, which helps regulate the temperature inside the building and improve energy efficiency. The enclosing structure 104 is made of a heat conductive element. Examples of the heat conductive element may include, but are not limited to, iron, steel, etc. For example, the enclosing structure 104 defines a chamber therewithin to receive the insulation layer 106.

The insulation layer 106 placed within the walls of the building may enhance the energy efficiency, comfort, and longevity of the building. For example, the insulation layer 106 may address thermal requirements, and acoustic requirements to create more sustainable and resilient built environments. Insulation in buildings serves several important purposes, primarily related to enhancing energy efficiency, maintaining thermal comfort, and contributing to overall building performance.

The apparatus 102 includes the projection array 108. For example, the projection array 108 is arranged in association with the insulation layer 106. Moreover, the projection array 108 includes a plurality of projections that extend within the insulation layer 106. Further, at least some of the plurality of projections of the projection array 108 are configured to host a humidity sensor to measure humidity data of the insulation layer 106. In an example, each of the projections may include an outlet, such as a power outlet. These power outlet may be used to host a humidity sensor, a temperature sensor, a heating element, or a vent for heat distribution. For example, at least some, such as two or more projections may host humidity sensor to collect humidity data of different regions of the insulation layer 106. Such regions may correspond to a surface area or an area within the insulation layer 106. In an example, one or more humidity sensors may be positioned along a length of the projections to enable the humidity sensors to reach the different regions, such as the surface areas, and areas of different depths within the insulation layer 106.

The apparatus 102 includes the heating element 110. The heating element 110 is mechanically coupled with the heat-conductive enclosing structure 104. The heating element 110 is configured to generate heat to cause the enclosing structure 104 to conduct heat to the insulation layer 106. In an example, the heating element is a material or device that converts electrical energy into heat or thermal energy. For example, the heating element 110 is supplied with a power source.

The apparatus 102 further includes the controller 112 communicatively coupled with the humidity sensor and the heating element 110. The controller 112 is configured to generate a control signal to trigger the heating element 110 based on a comparison between the humidity data and a humidity threshold. In an example, the humidity data may indicate a percentage or a score indicating a humidity level within an area where the corresponding humidity sensor and corresponding projection is located within or on the surface of the insulation layer 106. Based on a comparison between the humidity data and the humidity threshold, a determination is made whether the area for which the humidity data is compared is prone to mold growth or not. For example, if the humidity data or the detected humidity level corresponding to a region of the insulation layer 106 is greater than the humidity threshold, the controller 112 is configured to trigger the heating process. To trigger the heating process, the controller 112 is configured to generate a control signal to trigger the heating element 110. Since the heating element 110 is connected to the enclosing structure 104, the heat emitted by the heating element 110 is transferred or conducted to the enclosing structure 104. Further, the enclosing structure 104 along with the heating element 110 may heat the insulation layer 106 from different sides of the enclosing structure 104.

In an example, the controller 112 is connected with the humidity sensor and the heating element 110 using a communication network. The communication network may be wired, wireless, or any combination of wired and wireless communication networks, such as cellular, Wi-Fi, internet, local area networks, or the like. In some embodiments, the communication network may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

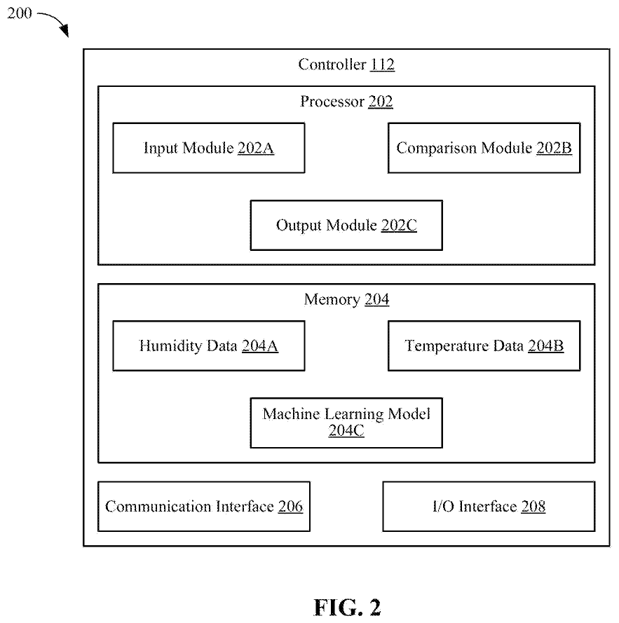

FIG. 2 illustrates a block diagram of the controller 112 of the apparatus 102, according to some embodiments. FIG. 2 is explained in conjunction with elements from FIG. 1. The controller 112 may include a processor 202, a memory 204, a communication interface 206, and an I/O interface 208. The processor 202 may be communicatively coupled to the memory 204, the communication interface 206, and the I/O interface 208.

The controller 112 may be a hardware device, a software program, or a combination thereof. The controller 112 is configured to manage or direct the flow of data between two entities. In an example, the controller 112 may be cards, microchips, or separate hardware devices for the control of a peripheral device, such as the heating element 110 and the humidity sensors of the projection array 108.

For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally, or alternatively, the processor 202 may include one or more processors capable of processing large volumes of workloads and operations to provide support for big data analysis. In an example embodiment, the processor 202 may be in communication with the other components of the controller 112 via a bus or the communication interface for passing information among components of the controller 112.

In an example, when the processor 202 is embodied as an executor of software instructions, the instructions may specifically configure the processor 202 to perform the algorithms and/or operations described herein when the instructions are executed. Pursuant to embodiments of present disclosure, the processor 202 of the controller 112 may implement or execute instructions to perform operations of the system 102 and/or the estimation model 104. However, in some cases, the processor 202 may be a processor specific device (for example, a mobile terminal or a fixed computing device) configured to employ an embodiment of the present disclosure by further configuration of the processors by instructions for performing the algorithms and/or operations described herein. The processor 202 may include, among other things, a clock, an arithmetic logic unit (ALU) and logic gates configured to support operation of the processor 202. In an example, the processor 202 includes an input module 202A, a comparison module 202B, and an output module 202C.

For example, the input module 202A is configured to receive, retrieve, obtain, or access input data. In an example, the input module 202A may utilize the communication interface 206 to obtain the input data. In an example, the input data may include sensor data, such as humidity data 204A, and temperature data 204B. The communication interface 206 may be wired, wireless, or any combination of wired and wireless communication networks, such as cellular, wireless fidelity (Wi-Fi), internet, local area networks, or the like.

The I/O interface 208 may include circuitry and/or software that may be configured to provide an output, such as transfer control signals to the heating element 110 for triggering the heating process, and receive, measure, or sense the input sensor data.

Further, the memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, the processor 202 of the controller 112). The memory 204 may be configured to store information, data, content, applications, instructions, or the like, for enabling the processor 202 of the controller 112 to conduct various functions in accordance with an example embodiment of the present disclosure.

As may be understood, the projection array 108 may have projections hosting sensors. In an example, an equal number or substantially equal number of projections may be provided at each of a pair of opposite sides of a substrate of the projection array 108. In other words, a set of projections are provided at a first side of the substrate facing one side of the insulation layer 106, and another set of projections are provided at a second side of the substrate facing another side of the insulation layer 106. The set of projections are in contact with a surface of the insulation layer 106 and/or a region within the insulation layer 106.

For example, some of the projections of the plurality of projections of the projection array 108 may host humidity sensors, and other projections may host temperature sensors. In an embodiment, certain projections in the projection array 108 may also host a heating element or a heat-conductive device that may be connected to the heating element 110 to transfer or conduct heat. In another embodiment, certain projections in the projection array 108 may also host vents that is configured to ensure proper distribution of the heat conducted by the heating element 110, the enclosing structure 104 and/or the heating element in the projections within the insulation layer 106. To this end, the humidity sensors may measure or sense humidity data 204A associated with different regions of the insulation layer 106. Similarly, the temperature sensors may measure, or sense temperature data associated with the different regions of the insulation layer 106. In this manner, humidity data 204A and temperature data 204B for the insulation layer 106 are measured.

In operation, the input module 202A is configured to obtain, retrieve, or receive the humidity data 204A and the temperature data 204B associated with the insulation layer 106. In an example, the input module 202A is connected to the humidity sensors and the temperature sensors provided at the projections of the projection array 108 via the communication interface 206. For example, one or more projections of the plurality of projections of the projection array 108 are provided with the humidity sensors to measure the humidity data 204A associated with the insulation layer 106 and temperature sensors to measure the temperature data 204B associated with the insulation layer 106.

Thereafter, the comparison module 202B is configured to compare the humidity data 204A with a humidity threshold. For example, the humidity threshold is a pre-defined threshold that indicates an ideal range of moisture that may be present in the insulation layer 106. For example, if the insulation layer 106, or a region in the insulation layer 106 has a humidity level greater than the humidity threshold then the insulation layer 106 or the region may be considered as damp or having high moisture.

To this end, the humidity data 204A sensed by a humidity sensor associated with a region may indicate a humidity level for the region. The comparison module 202B may compare the humidity level with the humidity threshold to ascertain a humidity condition of the region. When the humidity level of the region is greater than the humidity threshold, a high humidity condition prone to mold growth is ascertained. Alternatively, when the humidity level of the region is less than the humidity threshold, a low humidity condition that is not prone to mold growth is ascertained. In this manner, the humidity data 204A associated with different regions of the insulation layer 106 is compared with the humidity threshold to check if any region or the insulation layer 106 is prone to mold growth or not.

Based on the comparison, the output module 202C is configured to generate a control signal or an instruction to trigger the heating element 110. In particular, based on the determination that the humidity data 204A for any region of the insulation layer 106 is greater than the humidity threshold, i.e., prone to mold growth, the heating process is initiated by triggering the heating element 110. For example, the heating process is performed within a safe heating or temperature range of the insulation layer 106. For example, the heating process may be performed until the humidity data 204A of the insulation layer 106 is brought down, i.e., less than the humidity threshold.

In an example, the heating process comprises activating the heating element 110, adjusting one or more vents provided in the projections or connected to the enclosing structure 104, adjusting a humidity condition for the insulation layer 106, and/or deactivating the heating element 110 when a cut-off is reached.

It may be noted, during the heating process, the humidity data 204A and/or the temperature data 204B may be continuously retrieved by the input module 202A in real-time. Based on the continuously retrieved humidity data and/or the temperature data, the heating process, or an operation of the heating element 110 is controlled. For example, a temperature at which the heating element 110 operates or a time duration for which the heating element 110 operates may be controlled by the processor 202 of the controller 112.

In an embodiment, the heating process may be performed until a desired temperature is reached within the insulation layer 106. In this regard, the temperature data 204B retrieved from the temperature sensors may be used to monitor the temperature of the insulation layer 106.

In an embodiment, when the humidity data indicates that a humidity level of the insulation layer 106 has reached a cut-off, then another control signal may be generated for deactivating the heating element 110. Alternatively, or additionally, when the temperature data indicates that a temperature of the insulation layer 106 has reached a cut-off, then another control signal may be generated for deactivating the heating element 110.

In an example, the controller 112 includes a machine learning model 204C. The machine learning model 204C may be stored in the memory 204 and may be executed by the processor 202 to automatically trigger operation of the controller and/or the heating element. In an example, the machine learning (ML) model 204C is used to analyze and interpret complex patterns within the humidity data 204A and the temperature data 204B. The ML model 204C may be trained on historical environmental conditions and its impact on mold growth within different insulation materials as well as different geographical regions. For example, the ML model 204C may utilize the learned insights to predict when the insulation layer 106 is prone to mold growth. Subsequently, preventive heating of the insulation layer 106 may be performed to further decrease the possibility of mold growth. The ML model 204C enables proactively identifying areas at risk before mold growth. The ML model 204C adapts and refines its prediction over time, continually improving its accuracy based on evolving environmental dynamics. The apparatus 102 provides an intelligent and dynamic mold prevention strategy, enhancing the overall effectiveness of an insulated wall structure in creating a resilient and mold-resistance environment.

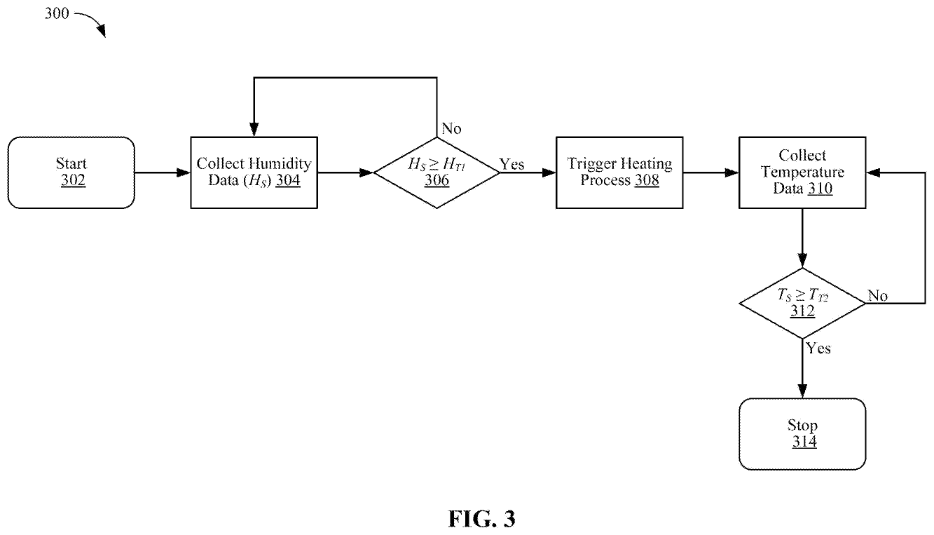

FIG. 3 illustrates a flowchart 300 of an exemplary method for preventing mold growth, according to some embodiments. FIG. 3 is explained in conjunction with elements of FIG. 1, and FIG. 2. Although illustrated with discrete blocks, the exemplary operations associated with one or more blocks of the flowchart 300 may be divided into additional blocks, combined into fewer blocks, or eliminated, depending on the particular implementation.

The exemplary method starts at 302.

At 304, humidity data (H_{S}) 204A is collected. The humidity data 204A is collected by the humidity sensors provided at some of the projections of the projection array 108.

In an embodiment, the projection array 108 is arranged in connection, such as physical connection with the insulation layer 106. In an example, a plurality of projection arrays may be arranged in association with the insulation layer 106. For example, the plurality of projections may extend from a first side of a substrate of the projection array 108 and may extend across a length of the insulation layer 106. In another example, the plurality of projections of the projection array 108 may extend from a first side of the insulation layer 106 and a plurality of projections of another projection array may extend from a second side of the insulation layer 106 across the length of the insulation layer 106.

Pursuant to an example embodiment, the plurality of projections of the projection array 108 extends perpendicularly from a surface of at least one of: a first side, or a second side opposite to the first side, of the projection array 108 within the two sides of the insulation layer 106. To this end, the first side and the second side of the projection array 108 may be opposing sides of the substrate of the projection array 108. In an example, if the projection array 108 is rectangular, then the first side and the second side are opposing longitudinal faces of the projection array 108.

Furthermore, the projections of the projections array 108 may host the humidity sensors to collect humidity data from different regions of the insulation layer 106. In an example, the different regions may be zones or areas within the insulation layer 106. In an example, the projections may be made such that the projections may extend and penetrate within the insulation layer 106 in different regions and at different angles.

Further, humidity data collected by a humidity sensor may indicate humidity condition or a level of humidity or moisture within a region associated with the humidity sensor. For example, the humidity sensor may be positioned within a particular region of an insulation layer form the insulation layer 106. The humidity sensor may measure and collect humidity data for the particular region. In this manner, humidity data 204A is collected for different regions of the insulation layer 106. For example, the humidity data is measured and collected in real-time within the enclosing structure 104.

At 306, a comparison between the humidity data 204A and a humidity threshold (H_{T1}) is performed. For example, the humidity data for different regions of the insulation layer 106 are compared with the humidity threshold. In an example, the humidity threshold is a pre-defined threshold. In another example, the humidity threshold is a dynamically determined threshold based on environmental or weather condition in which the apparatus 102 is operating. For example, in case of colder temperatures (such as during winter season), the humidity threshold may be set as a lower value, and in case of hot temperatures (such as during summer season), the humidity threshold may be set at a higher value. Subsequently, during winters, if humidity data for a region has higher humidity than the low humidity threshold, then mold prevention operation or the heating process is triggered. Alternatively, during summers, if humidity data for the region has higher humidity than the high humidity threshold, then mold prevention operation or the heating process is triggered. This ensures energy efficiency during different climatic conditions while ensuring proper mold prevention in the insulated wall structures.

In an example, if the humidity data for the region is less than the humidity threshold (H_{T1}), then heating process is not initiated. In such a case, the process of measuring and collecting humidity data using humidity sensors is continued until there is any abnormality, i.e., higher humidity level than the humidity threshold. In certain cases, the process of collecting humidity data 204A for different regions of the insulation layer 106 using humidity sensors and comparing the humidity data 204A with the humidity threshold may be performed repeatedly, such as multiple times in a day, once every day, once every 2 days, once every week, etc. For example, such frequency of the data collection and comparison to monitor mold growth may be pre-defined by a user of the apparatus 102 and/or may be determined based on the environmental and weather conditions. For example, the frequency of monitoring humidity data may be increased during the monsoon season and/or the winter season, while the frequency of monitoring humidity data may be decreased in the summer season.

To this end, if the humidity data (H_{S}) is greater than or equal to the humidity threshold, then the method moves to the 308.

At step 308, the heating process is triggered. In an example, the controller 112 is configured to generate a control signal to trigger the heating element 110 based on the comparison between the humidity data 204A and the humidity threshold (H_{T1}).

In an example, the heating process comprises activating the heating element 110, adjusting one or more vents, adjusting a humidity condition for the insulation layer 106, and deactivating the heating element 110 when a cut-off is reached. For example, the heating element 110 is activated by transmitting the control signal to the heating element 110 to initiate the heating process. The heating element 110 may conduct heat to the insulation layer 106 through the enclosing structure 104. In certain cases, some projections of the projection array 108 may also host heating elements. In such a case, the regions within the insulation layer 106 are heated by heating elements in the projections. Moreover, some projections of the projection array 108 may host vents. In certain other cases, the vents may be arranged within the enclosing structure 104. For example, the vents may be opening for exchange of gases. In an example, the vents may be openings or cavities that may allow moisture exchange from the insulation layer 106 to outside of the wall. In another example, the vents may be implemented using circulating devices, such as fans. This allows uniform heat dissipation across the regions of the insulation layer 106 and removal of moisture from the insulation layer 106. Due to the heat conduction from the heating element 110 and the circulation of air for heat distribution and moisture removal, the humidity condition of the insulation layer 106 is adjusted. For example, the humidity condition of the insulation layer 106 is adjusted to decrease a humidity level of the insulation layer 106 in the enclosing structure 104 of the apparatus 102.

Further, during the heating process, at 310, temperature data (T_{S}) 204B is collected. In this regard, temperature sensors are used to measure and collect the temperature data 204B. For example, some projections of the projection array 108 may host the temperature sensors. The temperature sensors may also be positioned within the insulation layer 106. For example, during the heating process, the temperature sensors may continuously retrieve temperature data 204B associated with different regions of the insulation layer 106. In an example, the temperature data 204B may indicate a temperature level (such as in degree Celsius or degree Fahrenheit) of the different regions of the insulation layer 106.

At 312, the temperature data 204B is compared with a temperature threshold (T_{T2}). For example, the temperature data 204B associated with a particular region of the insulation layer 106 is compared with the temperature threshold (T_{T2}). Based on the comparison, temperature parameter of the region of the insulation layer 106 is determined.

When a temperature level for the region or the insulation layer 106 is less than the temperature threshold, the heating process is continued. In other words, the heating element 110 remains active when the temperature level is less than the temperature threshold. Alternatively, when a temperature level for the region or the insulation layer 106 is greater than or equal to the temperature threshold, the cut-off is reached. When the cut-off is reached, the heating element 110 is deactivated. In this manner, the heating process is performed within a safe temperature range to heat the insulation layer 106. The safe heating ensures longevity of the insulation layer 106 without causing any faults in the insulation layer 106 while creating unfavorable condition for mold growth.

In an embodiment, the humidity sensors may also continually sense and collect humidity data for the different regions of the insulation layer 106 during the heating process in real-time. Subsequently, the controller 112 is configured to continuously retrieve the real-time humidity data after initiating the heating process. In an example, the humidity data collected in real-time is used to monitor humidity condition of the different regions. In such cases, the deactivation of the heating element 110 may be performed based on the real-time humidity data.

For example, the controller 112 is configured to determine whether current real-time humidity data from the retrieved real-time humidity data is substantially equal to a cut-off humidity threshold. The controller 112 is configured to compare the humidity level indicated by the retrieved real-time humidity data with the cut-off humidity threshold. In an example, when a current humidity level of a region of the insulation layer 106 or the insulation layer 106 is substantially equal to the cut-off humidity threshold, a cut-off condition is met.

Thereafter, based on the determination of the cut-off condition, the controller 112 is configured to generate a control signal for deactivating the heating element 110. The heating element 110 is deactivated to terminate the heating process. For example, when the humidity level is less than the cut-off humidity threshold, then moisture level is reduced, and mold growth condition has been averted. Subsequently, the heating process is deactivated or stopped.

Although the embodiments of the present disclosure are described with reference to a single apparatus 102 as an insulated wall structure. However, this should not be construed as a limitation. In other examples, the insulated wall structure may include plurality of apparatuses. Each of the apparatuses may include corresponding enclosing structures, controllers, and heating elements. Alternatively, the controller 112 and/or the heating element 110 may be used in conjunction with the different enclosing structures (similar to the enclosing structure 104) to collect data from the projection arrays of different enclosing structures to control the heating process.

The flowchart 300 terminates at 314.

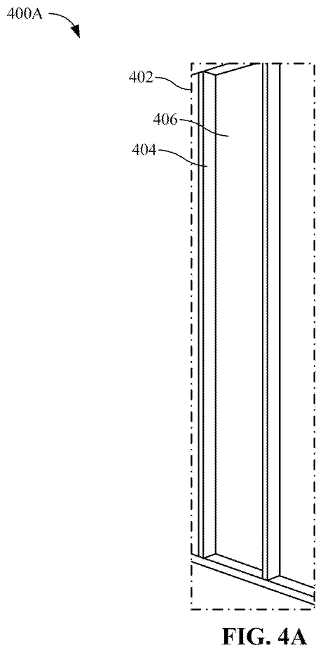

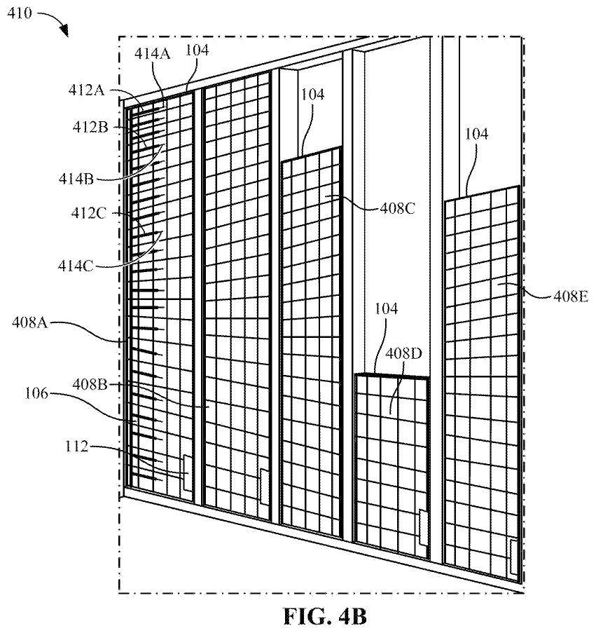

FIG. 4A illustrates an exemplary diagram 400A of a wall structure 402 for receiving an insulated module, according to some embodiments. The wall structure 402 forms a mould or a frame for receiving the insulated module. In this regard, the wall structure 402 includes a cavity 406 defined within a frame 404. The cavity 406 defines a hollow space for receiving the insulated module. Details of the insulated module are further described in conjunction with FIG. 4B, 5A and 5B.

FIG. 4B illustrates an exemplary diagram 410 of a plurality of insulated modules (depicted as insulated modules 408A, 408B, 408C, 408D and 408E) according to the present disclosure fitted within the wall structure 402, according to some embodiments. In an example, the apparatus 102 is used to implement the insulated walls 408A, 408B, 408C, 408D and 408E (collectively referred to as insulated walls 408) of a building. Examples of the building may include, but are not limited to, residential building, commercial building, educational buildings, storage building, and industrial building.

An insulated wall, say the insulated wall 408A may include the heat-conductive enclosing structure 104, the insulation layer 106 that provides insulation from the environmental conditions and the projection array 108 extending projections (depicted as projections 412A, 412B and 412C) within the insulation layer 106. In an example, the insulation layer 106 is an insulation foam. To this end, the insulation layer 106 is prone to mold growth because of high moisture levels. The insulation foam may be composed of various substances such as polystyrene, polyurethane, or cellulose. The insulation foam may have different densities and thicknesses depending on the desired thermal resistance and structural strength.

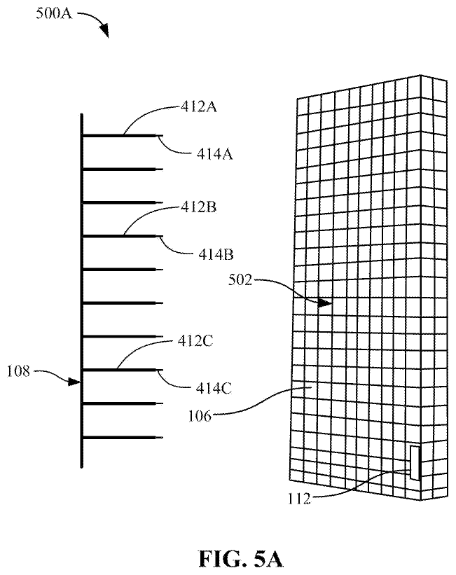

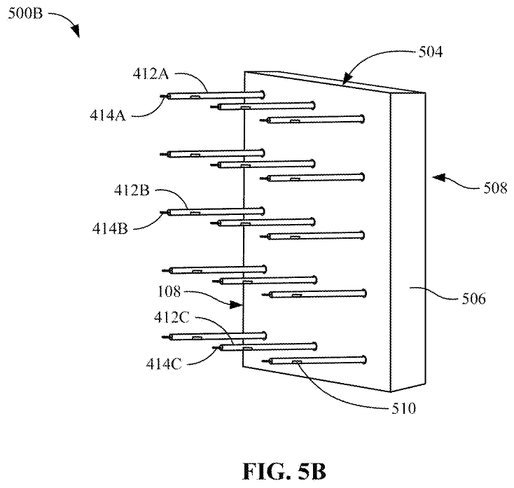

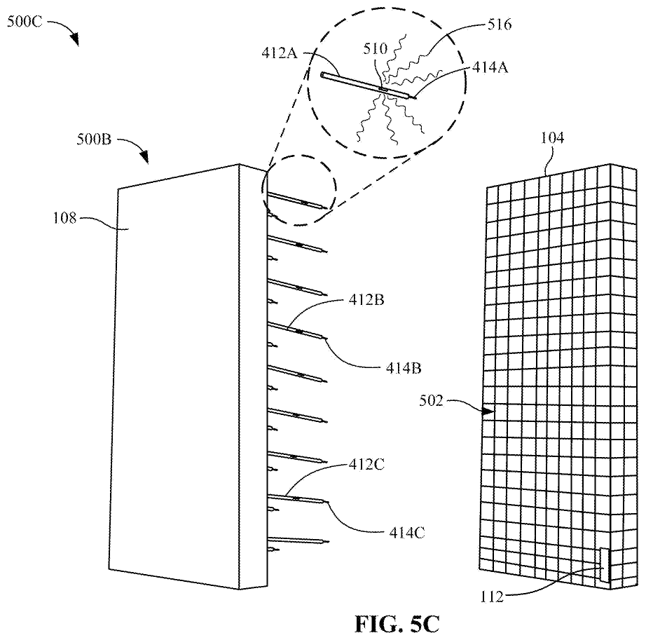

In an example, enclosing structure 104 is made of a heat-conductive material. For example, the enclosing structure 104 is made of iron mesh. The iron mesh structure of the enclosing structure 104 is described in detail in conjunction with FIG. 5A. The enclosing structure 104 is used to enclose the insulation layer inside the wall structure 402 of a building.

The projection array 108 includes the projections 412A, 412B and 412C. For example, each of the projections 412A, 412B and 412C may host humidity sensors 414A, 414B and 414C, respectively. The projections 412A, 412B and 412C (collectively referred to as projections 412) may position the humidity sensors 414A, 414B and 414C (collectively referred to as humidity sensors 414) into different regions of the insulation layer 106. The humidity sensors 414 may measure humidity data 204A and transmit the humidity data 204A to the controller 112. Additionally, the projections 412 may also host temperature sensors, vents, and heating elements for different regions of the insulation layer 106. Details of the projection array 108 are described in conjunction with FIG. 1, FIG. 2, and FIG. 5B.

Further, the heating element 110 (not shown in FIG. 4B) is mechanically coupled with the enclosing structure 104. The heating element 110 is supplied by a power source to generate heat. Further, the heat is transferred to the insulation layer 106 through conduction via the enclosing structure 104.

The controller 112 is communicatively coupled with the humidity sensors 414 and the heating element 110. The controller 112 is configured to receive the humidity data 204A of the different regions of the insulation layer 106. Further, the controller 112 is configured to compare humidity data of each region of the insulation layer 106 with a humidity threshold. Based on the comparison, the controller 112 may check if a region of the insulation layer 106 is damp or prone to mold growth. In an example, based on whether a humidity level is greater than the humidity threshold or not, mold growth condition is ascertained. When the humidity level is greater than the humidity threshold, the controller 112 may generate a control signal to activate the heating element 110 to trigger a heating process. Due to the heating, the moisture content of the insulation layer 106 is reduced, and mold growth is prevented. Further, the controller 112 is also configured to generate another control signal to deactivate the heating element 110 when a cut-off humidity threshold is reached and/or a cut-off temperature threshold is reached.

In an example, the controller 112 may utilize the ML model 204C to learn a correlation between the humidity data 204A, the temperature data 204B as well as environmental or weather information with an occurrence of mold growth in the insulation layer 106 of the wall structure 402. The ML model 204C is configured to, for example, predict when to initiate the heating process, dynamically determine the humidity threshold, and predict desired humidity level and/or desired temperature level for the insulation layer 106 to prevent mold growth.

In an embodiment, the controller 112 is configured to proactively communicate critical information to a user associated with the wall structure 402 through alert messages. The alert message serves to convey details, including real-time humidity data, and/or a status of heating element 110. The controller 112 is configured to transmit the alert message to a user device. The alert message act as a real-time notification system, providing users with insights into the ongoing status of the apparatus 102 or the insulated modules 408 of the wall structure 402.

FIG. 5A illustrates an exemplary schematic diagram 500A of the enclosing structure 104, according to some embodiments. The enclosing structure 104 is made of heat conductive material, such as but not limited to iron mesh net cage. The iron mesh cage is designed to define a chamber 502 to enclose the insulation layer 106 in the wall structure 402 and provide a proactive measure against mold formation.

The heating element 110 may get activated to initiate the heating process. Subsequently, the enclosing structure 104 may also conduct heat to the insulation layer 106 to dry out the moisture and prevent the growth of mold spores. The heating element 110 is in contact with the enclosing structure 104 to cause the enclosing structure 104 to transfer heat when the heating element 110 is activated. This means that the enclosing structure 102 may act as a heat conductor and distribute the heat to the insulation layer 106 of the wall structure 402.

In an example, a user may control and adjust the operation of the heating element 110 remotely, such as through a mobile app or a web interface executed on a user device. In this regard, the controller 112 is remotely connected to the user device. The controller 112 is configured to receive a control input from the user device. The control input is associated with a temperature control of the insulation layer 106. In an example, the control input may indicate a desired temperature value to regulate temperature of the building or a room associated with the wall structure 402. In an example, the temperature control may be for heating of the building or the room. For example, by using the apparatus 102 within the wall structure 402 as insulated modules 408, the mold growth prevention and temperature regulation within the building is performed simultaneously. This enhances energy efficiency of the building.

Further, the controller 112 is configured to generate a temperature control signal for the heating element 110 based on the control input. The controller 112 may transmit the temperature control signal to the heating element 110 to initiate the temperature control. In this manner, the temperature of the wall structure 402 within the building is regulated.

The projection array 108 having the projections 412 may be inserted into the enclosing structure 104. The projection array 108 is inserted such that the projections 412A, 412B and 412C penetrate within the insulation layer 106 in the enclosing structure 104.

FIG. 5B illustrates an exemplary schematic diagram 500B of the projection array 108, according to some embodiments. For example, the projection array 108 may include a plurality of projections 412. In an example, the projections 412 of the projection array 108 may extend from a single side or a first side 504 of a substrate 506. In another example, the projections of the projection array 108 may extend from the first side 504 as well as a second side 508 of the substrate 506. The first side 504 and the second side 508 may be opposing sides of the substrate 506 of the projection array 108. For example, the projections 412 may extend from the first side 504 of the substrate 506 towards the insulation layer 106.

In an example, the insulation layer 106 includes a plurality of regions, and wherein each of the plurality of regions includes at least one projection hosting the humidity sensor, at least one projection in connection with the heating element 110, and at least one projection hosting the temperature sensor. In other words, the different regions of the insulation are defined based on areas in which the projections 412 extend. Each of the regions of the insulation layer 106 is provided with a single projection hosting multiple sensors, heating element 510 and vents, or multiple projections. The projections 412 may have outlets supplied from a power source to host temperature sensor, humidity sensor and heating element 510. The temperature sensor of a projection, say the projection 412A may measure temperature data associated with a region of the projection 412A in the insulation layer 106; and the humidity sensor 414A of the projection 412A may measure humidity data associated with the region of the projection 412A of the insulation layer 106. Further, during the heating process, the projection 412A may perform localized heating of the region of the projection 412A using the heating element 510 that is in connection with the heating element 110.

The overall space of the insulation layer 106 within the enclosing structure 104 is compartmentalized into the plurality of regions, each region serving as a discrete unit for mold prevention. The segmentation of the insulation layer 106 further into the plurality of regions allows for targeted and zone-specific interventions, optimizing the efficiency of the apparatus 102. By dividing the insulation layer 106 into multiple regions, the apparatus 102 can more accurately assess and respond to variation in humidity levels. Each region of the insulation layer 106 is equipped with at least one humidity sensor hosted by a projection of the projection array 108 facilitating precise data collection for localized analysis. The humidity sensors continuously capture real-time moisture levels, providing essential data for mold growth.

Each of the projections 412 may include an outlet. The outlets of the projections 412 may host humidity sensors 414, temperature sensors, heating element 510 and/or or a vent for heat distribution. In an example, some projections from the projections 412 may host humidity sensors 414 such that the projections 412 that extend in each of different regions of the insulation layer 106 have at least one humidity sensor 414. Similarly, some of the projections from the projections 412 may host temperature sensors, vents, and heating elements. Subsequently, each of the different regions of the insulation layer 106 has at least one humidity sensor, temperature sensor heating element and vent. For example, the insulation layer 106 is divided into three different regions. In such a case, each of the three regions would include projections 412. The projection 412A in a region from the three regions would host the humidity sensor 414A, temperature sensor, heating element 510 and vent.

In an example, the heating elements 510 hosted by the projections 412 are in connection with the heating element 110. Subsequently, the heating element 110 may conduct heat to the insulation layer 106 through the projections 412 during the heating process.

In an example, the controller 112 is configured to detect a humidity condition for each of the plurality of regions of the insulation layer 106 based on the corresponding humidity data and the humidity threshold. Subsequently, the controller 112 is configured to transmit a control signal to the heating element 110 associated with the insulation layer 106 or projections in association with the heating element 110 to conduct heat in the at least one region to initiate the heating process.

The humidity condition may indicate if the regions of the insulation layer 106 have high moisture level or not such that the humidity condition is prone to mold growth or not. In an example, when the controller 112 determines that a particular region or a particular insulation layer is prone to mold growth, i.e., the humidity level indicated by the humidity data for the region or the insulation layer is higher than the humidity threshold, the controller 112 is configured to activate the heating element 110 to heat the particular region or the insulation layer 106. In an example, the heating element 110 may heat the insulation layer 106 by conducting heat through the enclosing structure 104. In another example, the heating element 110 may heat particular regions within the insulation layer 106 using heating element 510 hosted within the projection in the corresponding regions.

FIG. 5C illustrates an exemplary schematic diagram 500C of the enclosing structure 104 housing the projection array 108, according to some embodiments. The enclosing structure 104 defines the chamber 502 that receives the insulation layer 106.

The projection array 108 is arranged inside the enclosing structure 104. The projection array is arranged in association with the insulation layer 106. In an example, the projection array 108 is inserted from a front of the enclosing structure 104 or the insulation layer 106. In another example, the projection array 108 is inserted from a side of the enclosing structure 104 or the insulation layer 106. The projections 412 of the projection array 108 may extend across a width or a thickness of the insulation layer 106. Further, the humidity sensors 414 on the projections 412 of the projection array 108 may collect humidity data for different regions of the insulation layer 106.

For example, the projection 412A may host the humidity sensor 414A to measure humidity data for a region of the insulation layer 106. Further, the humidity sensor 414A or the projection array 108 may transmit the humidity data to the controller 112. The humidity data may be transmitted through wireless or wired network. The controller 112 may compare a humidity level indicated by the humidity data with the humidity threshold. Based on detecting that the humidity level of the region is greater than the humidity threshold, the controller 112 may send a control signal to the heating element 110 or the heating element 510 to trigger a heating process. During the heating process, the heating element 510 of the projection 412A may conduct heat 516 to the region of the insulation layer 106. In this manner, humidity in the insulation layer 106 is managed to prevent mold growth.

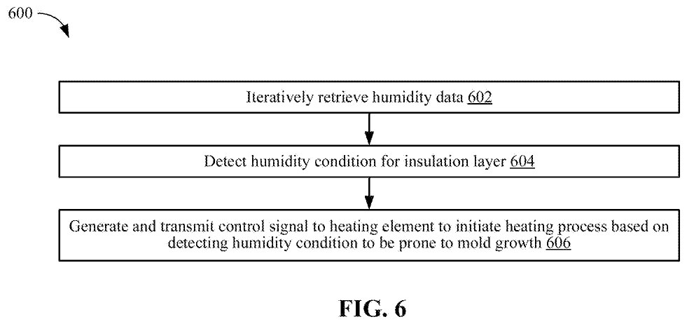

FIG. 6 illustrates a flowchart 600 of a method for preventing mold growth, according to some embodiments. FIG. 6 is explained in conjunction with elements from FIG. 1, FIG. 2, FIG. 3, FIG. 4A, FIG. 4B, FIG. 5A, FIG. 5B, and FIG. 5C. The operations of the flowchart 600 may be executed by any computing system, for example, by the controller 112.

At 602, humidity data 204A is iteratively retrieved. The humidity data 204A is retrieved by the controller 112 from humidity sensors 414 hosted by the projections 412 of the projection array 108. The projection array 108 is arranged in connection with the insulation layer 106. Subsequently, the projections 412 may extend from the substrate 506 of the projection array 108 to the different regions of the insulation layer 106. In an example, the humidity data collected from a humidity sensor for a region of the insulation layer 106 may indicate a humidity level.

At 604, humidity condition for the insulation layer 106 is detected. In an example, the controller 112 is configured to compare the humidity level indicated for the region of the insulation layer 106 with a humidity threshold to ascertain whether the region of the insulation layer 106 has high moisture level or not. When the humidity level is greater than or equal to the humidity threshold, high moisture is ascertained. In such a case, the humidity condition for the region of the insulation layer 106 is determined to be prone to mold growth.

At 606, a control signal is generated and transmitted to the heating element 110 to initiate a heating process. In an example, the controller 112 is configured to generate the control signal based on detecting the humidity condition to be prone to mold growth. The control signal may be transmitted to the heating element 110 to activate the heating element 110 and initiate the heating process. In an example, during the heating process, the heating element 110 may conduct heat to the insulation layer 106 via the enclosing structure 104. In another example, during the heating process, the heating element 110 may conduct heat to the insulation layer 106 via the enclosing structure 104 as well as targeted regions of the insulation layer 106 via the projection(s) in the region under consideration hosting the heating element. 510

During the heating process, real-time humidity data and real-time temperature data for the region is continuously retrieved. For example, when the controller 112 determines that a humidity level from the real-time humidity data is less than a cut-off humidity threshold, then another control signal is generated to deactivate the heating element 110, i.e., stop the heating process. Alternatively, or additionally, when the controller 112 determines that a temperature level from the real-time temperature data is more than a cut-off temperature threshold, then another control signal is generated to deactivate the heating element 110, i.e., stop the heating process. The control signals are transmitted to the heating element 110 through the communication module 206.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for controlling mold growth, comprising:
an enclosing structure defining a chamber therewithin to receive an insulation layer, wherein the enclosing structure is made of a heat conductive element;
a projection array arranged in association with the insulation layer, wherein the projection array comprises a plurality of projections extending within the insulation layer, and wherein at least some of the plurality of projections are configured to host a humidity sensor to measure humidity data of the insulation layer;
a heating element mechanically coupled with the enclosing structure, wherein the heating element is configured to generate heat to cause the enclosing structure to conduct heat to the insulation layer; and
a controller communicatively coupled with the humidity sensor and the heating element, wherein the controller is configured to generate a control signal to trigger the heating element based on a comparison between the humidity data and a humidity threshold.

2. The apparatus of claim 1, wherein a plurality of projection arrays is arranged within the insulation layer.

3. The apparatus of claim 1, wherein the plurality of projections of the projection array extends perpendicularly from a surface of at least one of: a first side, or a second side opposite to the first side, of the projection array within the insulation layer.

4. The apparatus of claim 1, wherein the heating process comprises at least one of: activating the heating element, adjusting one or more vents, adjusting a humidity condition for the insulation layer, and deactivating the heating element when a cut-off is reached.

5. The apparatus of claim 1, wherein one or more projections of the plurality of projections are in connection with the heating element, and wherein the heating element conducts heat to the insulation layer through the one or more projections during the heating process.

6. The apparatus of claim 1, wherein each of the plurality of projections includes an outlet for hosting at least one of: the humidity sensor, a temperature sensor, a heating element, or a vent for heat distribution.

7. The apparatus of claim 1, wherein the insulation layer includes a plurality of regions, and wherein each of the plurality of regions includes at least one projection hosting the humidity sensor, at least one projection in connection with the heating element, and at least one projection hosting a temperature sensor.

8. The apparatus of claim 7, wherein the controller is configured to:
detect a humidity condition for each of the plurality of regions of the insulation layer based on the corresponding humidity data and the humidity threshold; and
based on detecting the humidity condition for at least one region from the plurality of regions to be prone to mold growth, transmit a control signal to the at least one projection in connection with the heating element associated with the at least one region to initiate the heating process.

9. The apparatus of claim 1, wherein the controller is remotely connected to a user device, and wherein the controller is configured to:
receive a control input from the user device, wherein the control input is associated with a temperature control of the plurality of insulation layer;
generate a temperature control signal for the heating element based on the control input; and
transmit the temperature control signal to the heating element to initiate the temperature control.

10. The apparatus of claim 1, wherein the controller is configured to:
continuously retrieve real-time humidity data after initiating the heating process;
determine whether current real-time humidity data from the retrieved real-time humidity data is substantially equal to a cut-off humidity threshold; and
based on the determination, generate a control signal for deactivating the heating element.

11. The apparatus of claim 1, wherein one or more projections of the plurality of projections are provided with a temperature sensor to measure temperature data associated with the insulation layer.

12. The apparatus of claim 1, wherein the enclosing structure is made of iron mesh.

13. The apparatus of claim 1, wherein the enclosing structure is used to enclose the insulation layer inside a wall of a building.

14. An insulation module for a wall structure, comprising:
an enclosing structure defining a chamber therewithin to receive an insulation layer, wherein the enclosing structure is made of a heat conductive element;
a projection array arranged in association with the insulation layer, wherein the projection array comprises a plurality of projections extending within the insulation layer, and wherein at least some of the plurality of projections are configured to host a humidity sensor to measure humidity data of the insulation layer;
a heating element mechanically coupled with the enclosing structure, wherein the heating element is configured to generate heat to cause the enclosing structure to conduct heat to the insulation layer; and
a controller communicatively coupled with the humidity sensor and the heating element, wherein the controller is configured to generate a control signal to trigger the heating element based on a comparison between the humidity data and a humidity threshold.

15. The insulated wall structure of claim 14, wherein a plurality of projection arrays is arranged within the insulation layer.

16. The insulated wall structure of claim 14, wherein the plurality of projections of the projection array extends perpendicularly from a surface of at least one of: a first side, or a second side opposite to the first side, of the projection array within the insulation layer.

17. The insulated wall structure of claim 14, wherein the heating process comprises at least one of: activating the heating element, adjusting one or more vents, adjusting a humidity condition for the insulation layer, and deactivating the heating element when a cut-off is reached.

18. The insulated wall structure of claim 14, wherein one or more projections of the plurality of projections are in connection with the heating element, and wherein the heating element conducts heat to the insulation layer through the one or more projections during the heating process.

19. A method for controlling mold growth, wherein the method is implemented using an apparatus comprising:
an enclosing structure defining a chamber therewithin to receive an insulation layer, wherein the enclosing structure is made of a heat conductive element;
a projection array arranged in association with the insulation layer, wherein the projection array comprises a plurality of projections extending within the insulation layer, and wherein at least some of the plurality of projections are configured to host a humidity sensor to measure humidity data of the insulation layer;
a heating element mechanically coupled with the enclosing structure, wherein the heating element is configured to generate heat to cause the enclosing structure to conduct heat to the insulation layer; and
a controller communicatively coupled with the humidity sensor and the heating element, wherein the method comprises:
iteratively retrieving the humidity data;
detecting humidity condition for the insulation layer based on the humidity data and a humidity threshold; and
based on detecting the humidity condition to be prone to mold growth, generating and transmitting a control signal to the heating element to initiate a heating process.

20. The method of claim 19, further comprising:
receiving a control input from a user device, wherein the control input is associated with a temperature control of the insulation layer;
generating a temperature control signal for the heating element based on the control input; and
transmitting the temperature control signal to the heating element to initiate the temperature control.
